(19) United States
(12) Patent Application Publication
(10) Pub. No.: US 2025/0363370 A1
(43) Pub. Date: Nov. 27, 2025

(54) SELF EVOLUTION DECODING

(71) Applicant: Google LLC, Mountain View, CA (US)

(72) Inventors: Cyrus A. Rashtchian, San Diego, CA (US); Da-Cheng Juan, Sunnyvale, CA (US); Chun-Sung Ferng, Sunnyvale, CA (US); Hanxi Heinrich Jiang, Whippany, NJ (US); Jianyi Zhang, Durham, NC (US)

(21) Appl. No.: 19/215,030

(22) Filed: May 21, 2025

Related U.S. Application Data
(60) Provisional application No. 63/650,866, filed on May 22, 2024.

(51) Int. Cl. G06N 3/086; G06N 3/04

(52) U.S. Cl. CPC G06N 3/086; G06N 3/04

(57) ABSTRACT

Systems, methods, and apparatus for self-evolving decoding at inference. In an aspect, operations include processing, by a Large Language Model (LLM) of N layers, an input by an inference operation of the LLM; obtaining, from the LLM, logits [symbol] of an evolution layer of the LLM, the evolution layer being subsequent to a first layer of the LLM; for a plurality of layers that occur before the evolution layer, processing the logits of the layer with the logits of the evolution layer to generate an approximated gradient; based on the approximated gradient and the logits of the evolution layer, generating adjusted logits for the evolution layer; and processing the adjusted logits for the evolution layer to generate an output for the LLM.

### CROSS-REFERENCE TO RELATED APPLICATION

This application claims the benefit of priority under 35 U.S.C. § 119(e) to U.S. Provisional Application No. 63/650,866, filed on May 22, 2024, the contents of which are hereby incorporated by reference.

### BACKGROUND

A significant challenge associated with Large Language Models (LLMs) is their tendency to hallucinate or distort truth, resulting in output that is not factual. This failure undermines the reliability and trust of LLMs. To improve LLM factuality, several methods have been proposed, such as using retrieval techniques and external knowledge bases, fine tuning the model for better alignment, or employing ensemble learning with multiple models. Despite these efforts, there are still large gaps in understanding and improving LLM truthfulness.

In many cases LLMs have learned the factual content (based on extensive pre-training datasets), but they still fail to produce the correct answer when a user queries the model.

### SUMMARY

This specification describes systems and methods relating to LLMs, and in particular, to reducing hallucination or other factual errors in LLMs.

To enhance the reliability and truthfulness of large language models (LLMs), a Self-Evolution Decoding (SED) decoding strategy is used. The SED may also be referred to as a Self Logits Evolution Decoding (SLED) decoding strategy. The SED decoding does not rely on external knowledge bases or require additional fine-tuning, and is operative during inference. The SED decoding enhances the quality of LLM outputs by optimizing an implicit objective function using the inherent self-evolution of hidden states of LLMs. This approach allows for an ongoing refinement of outputs during inference, akin to further training, thus providing improved accuracy and interpretability over conventional decoding methods. Additionally, because the operations occur during inference, there is no need for model retraining. Moreover, the operations as implemented are optimized for efficiency and thus do not significantly impact inference time of the underlying LLM.

In an implementation, a computer-implemented method comprises processing, by a Large Language Model (LLM) of N layers, an input by an inference operation of the LLM; obtaining, from the LLM, logits [symbol] of an evolution layer of the LLM, the evolution layer being subsequent to a first layer of the LLM; for a plurality of layers that occur before the evolution layer, processing the logits of the layer with the logits of the evolution layer to generate an approximated gradient; based on the approximated gradient and the logits of the evolution layer, generating adjusted logits for the evolution layer; and processing the adjusted logits for the evolution layer to generate an output for the LLM. Other embodiments of this aspect include corresponding methods, apparatus, and computer programs, configured to perform the actions of the methods, encoded on computer storage devices.

In an implementation in combination with the above, obtaining, from the LLM, logits [symbol] of an evolution layer of the LLM, comprises obtaining, from the LLM, logits [symbol] of a final layer of the LLM, wherein the final layer of the LLM is the evolution layer.

In an implementation of any of the above, for the plurality of layers that occur before the evolution layer, the operation of processing the logits of the layer with the logits of the evolution layer to generate an approximated gradient comprises for each layer of the plurality of layers that occur before the evolution layer, processing the logits of the layer with the logits of the evolution layer to generate an approximated gradient.

In an implementation of any of the above, the operations include for each layer of a plurality of layers that occur before the evolution layer, processing a distribution of the layer and a distribution of the final layer to determine a distance from the approximated gradient; and for each layer of the plurality of layers that occur before the evolution layer, determining, for the layer, weights that are indicative of how closely a difference between the logits of the layer and the logits of the final layer align with the approximated gradient.

In an implementation of any of the above, the operations include determining, based on the weights, a weighted average for each layer; and adjusting the logits of the evolution layer based, in part, on the weighted averages determined for the layers.

In an implementation of any of the above, processing the logits of the layer with the logits of the evolution layer to generate an approximated gradient comprises processing a proper subset of the logits of the layer, the proper subset of the logits of the layer corresponding to a set of top k logits of a layer, where k is a value that is fewer than a total number of logits in the layer.

In an implementation of any of the above processing a proper subset of the logits of the layer comprises processing the proper subset of the logits of the layer that correspond to the top k logits of the evolution layer.

In an implementation of any of the above, for each of a plurality of layers that occur before the evolution layer, processing the logits of the layer with the logits of the evolution layer to generate an approximated gradient comprises for each layer from an initial layer to the evolution layer, processing the logits of the layer with the logits of the evolution layer to generate the approximated gradient.

In an implementation of any of the above, obtaining, from the LLM, logits [symbol] of an evolution layer of the LLM, comprises obtaining, from the LLM, logits [symbol] of a final layer of the LLM, wherein the final layer of the LLM is the evolution layer.

The language model can be any appropriate language model neural network that receives an input sequence made up of text tokens selected from a vocabulary and auto-regressively generates an output sequence made up of text tokens from the vocabulary. For example, the language model can be a Transformer-based language model neural network or a recurrent neural network-based language model.

The above implementations may realize one or more of the following advantages. The decoding strategy supports a wide range of model families, including more advanced architectural configurations such as the mixture of experts (MoE). The decoding strategy scales efficiently and does not significantly impact inference time.

The decoding strategy is versatile across a variety of tasks, such as multiple-choice questions, open-ended generation, and adaptations to chain-of-thought reasoning tasks.

The decoding strategy can be flexibly combined with other decoding methods, enhancing their performance and broadening the scope of its applicability. This interoperability facilitates tailored deployment in systems that require specific decoding enhancements.

The decoding strategy mitigates repetition issue existing in previous factuality methods, ensuring the fluency and high quality of responses. The decoding strategy also realizes negligible additional computational costs, suitable for real-time applications.

The decoding strategy provides a new interpretable framework for inference-time computing algorithms, enhancing the development and interpretability of advanced factuality decoding.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a factual decoding process.

FIG. 2 is a system block diagram of a self-evolution decoding system.

FIG. 3 is an evolution flow diagram for logit evolutions.

FIG. 4 is an example algorithm for self-logits evolution decoding.

FIG. 5 is a flow diagram of an example process of self-logits evolution decoding.

Like reference numbers and designations in the various drawings indicate like elements.

### DETAILED DESCRIPTION

Described below is a self-evolving decoding system that enhances the truthfulness of LLMs without relying on external knowledge bases or requiring further fine-tuning or training. From an optimization perspective, the system leverages the latent knowledge embedded within the LLM by contrasting the output logits from an evolution layer with those from layers that precede the evolution layer. In some implementations, the evolution layer is a final layer of the LLM. The system then utilizes an approximate gradient approach to enable latent knowledge to guide the self-refinement of outputs, thereby effectively improving factual accuracy.

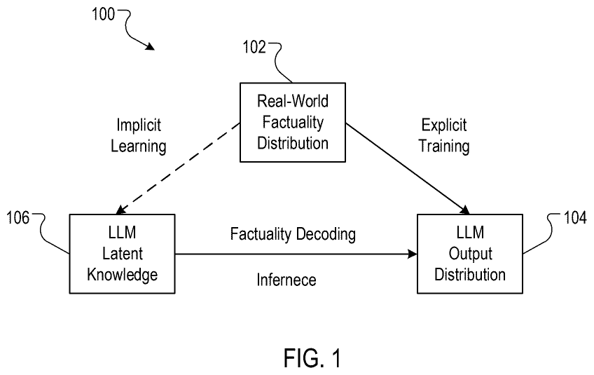

FIG. 1 is a block diagram 100 of a factual decoding process. A model is trained on a real-world factuality distribution 102. For example, the real-world factuality distribution 102 may be ground truth data of a training corpus. After training, the model generates an output distribution 106 at inference time. The factual decoding process leverages the latent knowledge 106 of the LLM during inference and adjusts the output distribution 106 of the model. The goal of the adjustment is to increase accuracy of the model and reduce hallucinations.

The decoding process of FIG. 1 is a strategy framework for improving the LLM factuality. Decoding focuses on how the model selects a next token during the generation process, which can significantly influence the factual accuracy of the output. The decoding processes of this framework can be cost-effective since they do not rely on external knowledge and no additional training is required. Furthermore, decoding methods can be synergistically combined with other techniques aimed at improving the LLM factuality, such as retrieving information from external knowledge bases, various fine-tuning strategies for better alignment, or ensemble learning methods.

A common issue with LLMs is learning factual content based on extensive pretraining or fine-tuning, yet failing to produce the correct answer when a user queries the model. Factuality decoding reveals what the model implicitly “knows.” As summarized in FIG. 1, the output distribution is derived by applying the softmax function to the output logits from an evolution layer, which is typically the final layer. Other layers, such as a penultimate layer, can also be used, however.

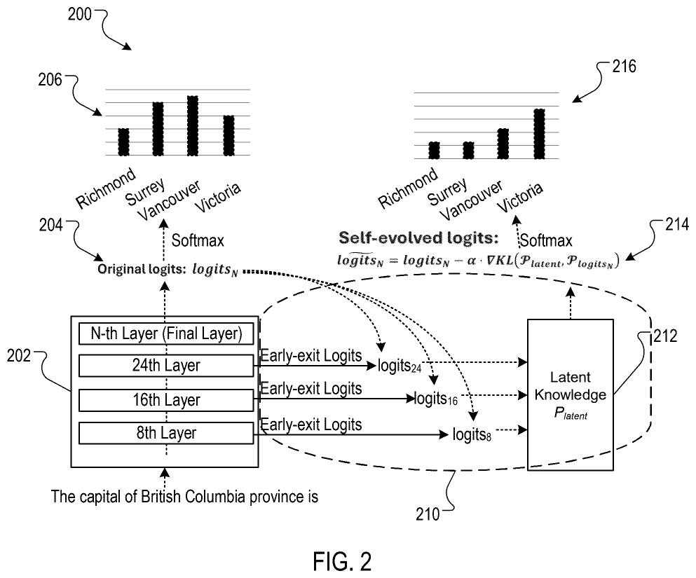

During the training phase, this distribution is optimized based on the real-world factuality distribution represented by the training dataset. However, during the inference phase, the LLM output might still contain factual errors, which implies a discrepancy between the output distribution and the real-world factuality distribution. While the real-world distribution remains inaccessible during the inference phase, the model's latent knowledge may have implicitly learned some factual content correctly during the training phase. The subject matter of this disclosure is a decoding strategy that effectively harnesses the latent knowledge embedded within LLMs to refine the output distribution (logits) during inference. This decoding strategy is illustrated in FIG. 2, which is a system block diagram of a self-evolution decoding system 200.

The self-evolution decoding system 200 leverages the latent knowledge within LLMs by contrasting an evolution layer's logits with logits of earlier layers. For the remainder of this description, the evolution layer is the final layer of the LLM. However, a layer before the final layer of the LLM can also be used as the evolution layer, so long as the layer so used has preceding layers for comparison. Thus, while the term “final layer” is used in this description, it is to be understood that an earlier layer, such as a penultimate layer, or an even earlier layer, can also be used for evaluation.

During the decoding process, as LLMs progress from early to final layers, they progressively incorporate factual information stored in each layer into the output. The system 200 tracks this evolution process to access latent knowledge within LLMs, and enables the self-evolution of the output distribution further to align it more closely with real-world facts. However, the latent knowledge within LLMs, while valuable, may not always be accurate. Thus, in some implementations, the system 200, instead of simply replacing the original outputs with this latent knowledge, integrates it into the original logits through an operation similar to a gradient descent over the output logits during the inference time. This operation reduces divergence between the latent knowledge distribution and the output distribution, effectively balancing the two and mitigating potential drawbacks such as overfitting or biased outputs.

As illustrated in FIG. 2, an input “The capital of British Columbia province is” is input to an LLM 202 with N layers. An initial distribution for output logits 204 logits_{N} reveals an incorrect prediction of “Vancouver,” as indicated by the most prominent probability.

As will be described in more detail below, a self-logits evolution decoding process 210 is used to harness the latent knowledge 212 Pₗₐₜₑₙₜ to generate self-evolved logits 214. The self-evolved logits are then processed to generate an adjusted output distribution 216 that reveals a correct prediction of “Victoria.”

A large language model, equipped with N layers and a vocabulary V=[v₁, v₂, . . . , v_{d}], typically generates text in the next-token prediction fashion. For each given prefix, the model computes the logits at the final (N-th) layer, logits _{N} [symbol] ( [symbol] _{(1,N)}, [symbol] _{(2,N)}, . . . , [symbol] _{(d,N)}), which are obtained by applying a linear transformation to the hidden states of the final layer, projecting the high-dimensional hidden state vectors onto the space of the vocabulary size. Subsequently, the output distribution [symbol] _{logits}_{_{N}} at the final (N-th) layer for the next token is derived by applying softmax function on the logits:

$${𝒫}_{{logits}_{N}} {=}^{Δ} ( {p}_{( 1 , N )} , ... , {p}_{( d , N )} ) = soft max ( \frac{log {its}_{N}}{τ} ) ,$$

where τ is the temperature parameter. Therefore, for each p_{(i,N)}(1≤i≤d), the resulting probabilities are:

$${p}_{( i , N )} = \frac{exp ( \frac{{ℓ}_{( i , N )}}{τ} )}{S} , where S = {\sum }_{j = 1}^{d} exp ( \frac{{ℓ}_{( j , N )}}{τ} ) .$$

Similarly, logits are derived from early layers by applying the same linear transformation above to their hidden states. Thus, for any early layer n(n<N), the logits are denoted as: logits ₙ [symbol] ( [symbol] _{(1,n)}, . . . , [symbol] _{(d,n)}), and the corresponding distribution is denoted as:

$${𝒫}_{{logits}_{n}} {=}^{Δ} ( {p}_{( 1 , n )} , ... , {p}_{( d , n )} ) .$$

To improve factual accuracy, the correct token vᵢ receives a higher value of logits_{N} to ensure a higher probability value p_{(i,N)} in the output distribution [symbol] _{logits}_{_{N}}. This essentially aligns the model's output distribution [symbol] _{logits}_{_{N}} closely with the real-world factuality distribution [symbol] ᵣₑₐₗ. This goal can be expressed as optimization, and a variety of optimization can be used. One example optimization is the following loss function [symbol] regarding the logits:

$$ℒ ( log its ) {=}^{Δ} KL ( {𝒫}_{real} , {𝒫}_{logits} ) , \\ where log its = ( {ℓ}_{1} , ... , {ℓ}_{d} ) , {𝒫}_{logits} = soft max ( log its / τ ) \qquad ( 1 )$$

The loss function of equation (1) is also referred to as a logits evolution.

The training of LLMs aims at minimizing the divergence (typically the KL divergence, as the training loss function is often the cross-entropy loss) between the ground truth [symbol] ᵣₑₐₗ and the output distribution [symbol] _{logits}_{_{N}}. During the training phase, the logits evolution is driven externally by the real-world distribution [symbol] ᵣₑₐₗ presented in the training dataset, and the corresponding solution is logits=logits_{N}. However, [symbol] ᵣₑₐₗ is not accessible during the inference phase. To address this, the system 200 utilizes the model's latent knowledge to estimate [symbol] ᵣₑₐₗ, which enables self-evolution of the logits. This estimation is denoted as [symbol] ₗₐₜₑₙₜ and the self-logits evolution can be achieved by the following gradient-descent operation:

$$= log {its}_{N} - α \cdot {∇}_{{logits}_{N}} KL ( {𝒫}_{latent} , {𝒫}_{{logits}_{N}} ) . \qquad ( 2 )$$

The parameter α defines an Evolution Rate that governs the magnitude of adjustments applied to logits_{N} in the direction of the gradient ∇_{logits}_{_{N}}KL( [symbol] ₗₐₜₑₙₜ, [symbol] _{logits}_{_{N}}). The evolution rate can be set based on empirical data, sensitivity requirements, or any other appropriate factor.

In some implementations, to derive the [symbol] ₗₐₜₑₙₜ as the estimation of the real-world distribution [symbol] ᵣₑₐₗ, [symbol] ᵣₑₐₗ is estimated by tracking logits evolution through the layers. The system 200 leverages the difference between each early layer's logits and the final layer's logit, i.e., logitsₙ−logits_{N}, to approximate the gradient of KL( [symbol] ᵣₑₐₗ, [symbol] _{logits}) at logits=logitsₙ. The system 200 then estimates [symbol] ᵣₑₐₗ based on this approximation.

As described above, a trained model generates a final layer logits logits=logits_{N} because the final layer's logits_{N} directly engage with the real-world distribution [symbol] ᵣₑₐₗ through the loss function in training. This leads to the implication that the final logits logits_{N} are a better solution than the logits from an early layer logits n, given KL( [symbol] ᵣₑₐₗ, [symbol] _{logits}_{_{N}})<KL( [symbol] ᵣₑₐₗ, [symbol] _{logits}_{ₙ}). Thus, by contrasting the final layer's logits with the early layer's logits, the direction (orientation) of logitsₙ−logits_{N} can approximately align with the direction of the gradient

$${∇}_{logits} KL ( {𝒫}_{real} , {𝒫}_{logits} ) {\vert}_{logits = {logits}_{n}} .$$

Accordingly, for each early layer n, the following function of cosine similarity is maximized to derive the

$${𝒫}_{latent}^{( n )}$$

as the estimate the [symbol] real:

$${𝒫}_{lat \vert ent}^{( n )} = arg {max}_{𝒫} ( Cos Sim ( log {its}_{n} - log {its}_{N} , {∇}_{{logits}_{n}} KL ( 𝒫 , {𝒫}_{{logits}_{n}} ) , 0 ) \qquad ( 3 )$$

The cosine similarity measures the similarity between logitsₙ−logits_{N} and ∇_{logits}_{ₙ}KL( [symbol] ᵣₑₐₗ, [symbol] _{logits}_{ₙ}), and thus is a distance of the difference between the approximation of the gradient and the logits vectors. In particular, the similarity is a measure of the difference of distributions of the layer and a distribution of the final layer to the approximated gradient.

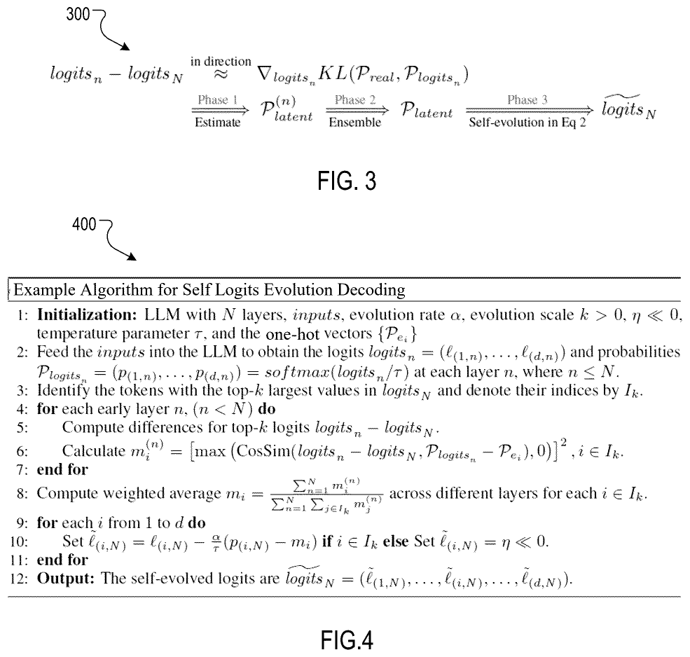

In some implementations, the system 200 generates the self-evolution of logits in multiple phases. The phases are depicted in FIG. 3, which is an evolution flow diagram 300 of logit evolutions. An example algorithmic implementation 400 of FIG. 3 is shown in FIG. 4.

First, the system 200 estimates

$${𝒫}_{latent}^{( n )}$$

for each early layer n using the gradient approximation described above. Subsequently, the system 200 applies a weighted average on

$$\{ {𝒫}_{latent}^{( n )} \}$$

across all early layers n<N to derive [symbol] ₗₐₜₑₙₜ, which serves as the final estimation of the real-world distribution. Finally, the system 200 apply [symbol] ₗₐₜₑₙₜ in Equation (2) to facilitate the self-evolution of logits_{N}, thereby derive the updated logits, [symbol] . Each phase is described in more detail below.

For the first phase, an exhaustive search for an exact solution to the complex optimization problem of Equation (3) is computationally impractical. Thus, the system 200 reduces the solution space based on the assumption that the real-world factuality distribution dictates that the next word to be generated is the i-th token vᵢ from the vocabulary V. Thus [symbol] ᵣₑₐₗ= [symbol] ₑ_{ᵢ}, where [symbol] ₑ_{ᵢ} represents a standard basis vector (one-hot vector) with the i-th component set to 1 and all other components set to 0. Accordingly, the system 200 limits the solution space to the optimization problem to

$${\{ {𝒫}_{{e}_{i}} \}}_{i = 0}^{d}$$

and decides which token i should be selected.

The corresponding gradient when [symbol] = [symbol] ₑ_{ᵢ} has the following formulation. Consider the gradient of KL( [symbol] ₑ_{ᵢ}, [symbol] _{logits}) at logits=logitsₙ is:

$${∇}_{{logits}_{n}} KL ( {𝒫}_{{e}_{i}} , {𝒫}_{{logits}_{n}} ) = \frac{( {𝒫}_{{logits}_{n}} - {𝒫}_{{e}_{i}} )}{τ} = \frac{( {p}_{( 1 , n )} , ... , {p}_{( i , n )} - 1 , ... , {p}_{( d , n )} )}{τ} \qquad ( 4 )$$

The cosine similarity between the gradient ∇_{logits}_{ₙ}KL( [symbol] ₑ_{ᵢ}, [symbol] _{logits}_{ₙ}) and the difference logitsₙ−logits_{N} is calculated for each token in the vocabulary V. The [symbol] ₑ_{ᵢ}* of which the gradient is closest to logitsₙ−logits_{N} is selected as the estimation

$${𝒫}_{latent}^{( n )} .$$

The selection of i* is done according to the following criterion:

$${i}^{*} = arg {max}_{1 \leq i \leq d} {\overline{m}}_{i}^{( n )} , \\ where {\overline{m}}_{i}^{( n )} = max ( Cos Sim ( log {its}_{n} - log {its}_{N} , {𝒫}_{{logits}_{n}} - {𝒫}_{{e}_{i}} ) , 0 )$$

and adopting

$${𝒫}_{latent}^{( n )} = {𝒫}_{{e}_{{i}^{*}}}$$

as the hard estimation of [symbol] ᵣₑₐₗ. Based on the concept of hard and soft targets in label smoothing and knowledge distillation, that can be extended to the soft estimation:

$${𝒫}_{latent}^{( n )} = \frac{( {m}_{1}^{( n )} , ... , {m}_{i}^{( n )} , ... , {m}_{d}^{( n )} )}{{m}^{( n )}} , \\ where {m}_{i}^{( n )} = {( {\overline{m}}_{i}^{( n )} )}^{2} and {m}^{( n )} = {\sum }_{i = 1}^{d} {m}_{i}^{( n )}$$

The value of

$$\{ {\overline{m}}_{i}^{( n )} \}$$

is optionally squared to moderately amplify their differences, as shown in FIG. 4. In some implementations, the system 200 adopts the soft estimation in lieu of the hard estimation.

During the second phase, the system 200 ensembles

$${𝒫}_{latent}^{( n )}$$

across all layers by computing a weighted average of the set

$$\{ {𝒫}_{latent}^{( n )} \}$$

and adopts it as the final estimation of the [symbol] ₗₐₜₑₙₜ, again as indicated in FIG. 4:

$${𝒫}_{latent} = {\sum }_{n = 0}^{N} {s}^{( n )} {𝒫}_{latent}^{( n )} , where {s}^{( n )} = \frac{{m}^{( n )}}{( {\sum }_{n = 0}^{N} {m}^{( n )} )}$$

Note that this estimation suggests that the weight s⁽ⁿ⁾ of certain layer n will be larger if the corresponding gradient approximation logitsₙ−logits_{N} is more closely aligned with the gradients {∇_{logits}_{ₙ}KL( [symbol] ₑ_{ᵢ}, [symbol] _{logits}_{ₙ})} for the tokens in the vocabulary. This, in turn, amplifies the influence of layer n on the final estimation. The weights are thus indicative of how closely a difference between the logits of the layer and the logits of the final layer align with the approximated gradient. Additionally, for each component mᵢ in the final estimation [symbol] ₗₐₜₑₙₜ [symbol] (m₁, m₂, . . . , m_{d}), the following relationship is true:

$${m}_{i} = {\sum }_{n = 0}^{N} {m}_{i}^{( n )} / ( {\sum }_{n = 0}^{N} {\sum }_{j = 1}^{d} {m}_{j}^{( n )} ) .$$

This property can be used to simplify the algorithm of FIG. 4.

The application of [symbol] ₗₐₜₑₙₜ in Equation 2 enables the system 200, during the third phase, to derive the gradient necessary for steering the self-evolution on the final layer's logits logits_{N}. In particular, the gradient of KL( [symbol] ₗₐₜₑₙₜ, [symbol] _{logits}) at logits=logits_{N} is:

$${∇}_{{logits}_{N}} KL ( {𝒫}_{latent} , {𝒫}_{{logits}_{N}} ) = ( {𝒫}_{{logits}_{N}} - {𝒫}_{latent} ) / τ = ( {p}_{( 1 , N )} - {m}_{1} , … , {p}_{( d , N )} - {m}_{d} ) / τ$$

Accordingly, the self-evolved logits [symbol] can be derived as:

$${=}^{Δ} ( {\tilde{ℓ}}_{( 1 , N )} , ... , {\tilde{ℓ}}_{( i , N )} , ... , {\tilde{ℓ}}_{( d , N )} ) , \\ where {\tilde{ℓ}}_{( i , N )} = {ℓ}_{( i , N )} - α ( {p}_{( i , N )} - {m}_{i} ) / τ \qquad ( 5 )$$

These self-evolved logits [symbol] , as indicated in FIG. 4, can then be processed as the adjusted logits for the evolution layer to generate an output for the LLM. Note that relying solely on Pₗₐₜₑₙₜ as the output can lead to inaccuracies, as the latent knowledge can be imperfect. The original logits logits_{N} reflect the knowledge obtained directly by real-world data during training. The evolution rate α in Equation (2) serves to balance this trade-off, enabling a reciprocal enhancement between Pₗₐₜₑₙₜ and the original logits_{N}.

Additionally, in some implementations, the difference logitsₙ−logits_{N} is used as an estimated gradient. However, this estimation is unconstrained, and which can lead to a mismatch in magnitudes and could also introduce unexpected noise. The gradients estimated in Equation (2), however, are constrained within [−1, 1], which reduces the likelihood of such errors.

To further increase computational efficiency, only a proper subset of the top k logits of a layer are processed. The value of k is a value that is fewer than a total number of logits in the layer. This is because for each layer, computing the cosine similarity for every token vᵢ in the vocabulary V requires O(d²) operations. Thus, to reduce the computational complexity, the system 200 select only a subset V_{I}_{ₖ}, where the token vᵢ∈V_{I}_{ₖ} has the top-k highest logits in the final (evaluation) layer. For this implementation, the self-evolution in Equation 2 is done only on the logits corresponding to these top-k tokens. Further, in some implementations, for the remaining tokens, which have lower probabilities, the system 200 adjusts the logits to a very low numerical value, e.g., −1000. This adjustment significantly reduces the computational complexity while maintaining focus on the most relevant tokens. The parameter k is referred to as the evolution scale, since it determines the number of top-probability tokens active for self-evolution. The value of k can be chosen based on inference time constraints, computations resource constraints, or other factors.

In other implementations, only a proper subset of the layers are processed. For example, if the LLM has 32 layers, and the evolution layer is the final layer (layer 32), then only layers 4, 8, 12, 16, 20, 24 and 28 logits are processed against the evolution layer.

In some implementations, the system 200 processes logits of each layer subsequent to the evolution layer. For example, if LLM has 32 layers, and the evolution layer is the final layer (layer 32), then for each layer 1-31, the logits are processed against the evolution layer. This ensemble approach reduces noise and/or bias in logit evolution when compared to selecting fewer layers, or only a layer or subset of layers for which there is a maximum divergence from the evolution layer.

The system 200 described above also enables the evolution of logits without additional training of the underlying LLM. This enables an accuracy improvement and reduces hallucination by a process that can be done without noticeably impacting inference time.

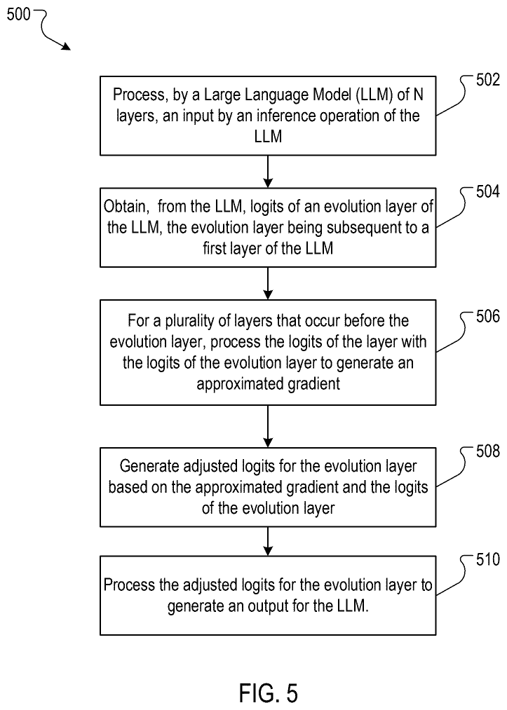

FIG. 5 is a flow diagram of an example process 500 of self-evolution decoding. The process 500 can be implemented in a data processing apparatus that includes one or more processors that executed instructions that cause the processors to perform the operations described for the process 500.

The process 500 processes, by a LLM of N layers, an input by an inference operation of the LLM (502). For example, as depicted in FIG. 2, the input “The capital of British Columbia province is” may be provided as input to the LLM.

The process 500 obtains, from the LLM, logits [symbol] of an evolution layer of the LLM, the evolution layer being subsequent to a first layer of the LLM (504). For example, as depicted in FIG. 2, the original logits, logits_{N} are obtained.

The process 500, for a plurality of layers that occur before the evolution layer, processes the logits of the layer with the logits of the evolution layer to generate an approximated gradient (506). For example, as illustrated by FIG. 2 and as described above, the logits of the evolution layer and corresponding logits of layers previous to the evolution layer are processed to generate and approximated gradient.

The process 500, based on the approximated gradient and the logits of the evolution layer, generates adjusted logits for the evolution layer (508). For example, as illustrated in FIG. 2 and as described above, the logits [symbol] are generated.

The process 500 processes the adjusted logits for the evolution layer to generate an output for the LLM (510). For example, as illustrated in FIG. 2, a softmax is applied to the logits [symbol] to generate the output of the LLM.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally, or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device, “data processing apparatus,” or “hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively, or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
processing, by a Large Language Model (LLM) of N layers, an input by an inference operation of the LLM;
obtaining, from the LLM, logits [symbol] of an evolution layer of the LLM, the evolution layer being subsequent to a first layer of the LLM;
for a plurality of layers that occur before the evolution layer, processing the logits of the layer with the logits of the evolution layer to generate an approximated gradient;
based on the approximated gradient and the logits of the evolution layer, generating adjusted logits for the evolution layer; and
processing the adjusted logits for the evolution layer to generate an output for the LLM.

2. The computer-implemented method of claim 1, wherein obtaining, from the LLM, logits [symbol] of an evolution layer of the LLM, comprises obtaining, from the LLM, logits [symbol] of a final layer of the LLM, wherein the final layer of the LLM is the evolution layer.

3. The computer-implemented method of claim 2, wherein for the plurality of layers that occur before the evolution layer, processing the logits of the layer with the logits of the evolution layer to generate an approximated gradient comprises for each layer of the plurality of layers that occur before the evolution layer, processing the logits of the layer with the logits of the evolution layer to generate an approximated gradient.

4. The computer-implemented method of claim 2, wherein generating adjusted logits for the evolution layer comprises:
for each layer of a plurality of layers that occur before the evolution layer, processing a distribution of the layer and a distribution of the final layer to determine a distance from the approximated gradient; and
for each layer of the plurality of layers that occur before the evolution layer, determining, for the layer, weights that are indicative of how closely a difference between the logits of the layer and the logits of the final layer align with the approximated gradient.

5. The computer-implemented method of claim 4, further comprising:
determining, based on the weights, a weighted average for each layer; and
adjusting the logits of the evolution layer based, in part, on the weighted averages determined for the layers.

6. The computer-implemented method of claim 1, wherein processing the logits of the layer with the logits of the evolution layer to generate an approximated gradient comprises processing a proper subset of the logits of the layer, the proper subset of the logits of the layer corresponding to a set of top k logits of a layer, where k is a value that is fewer than a total number of logits in the layer.

7. The computer-implemented method of claim 6, wherein processing a proper subset of the logits of the layer comprises processing the proper subset of the logits of the layer that correspond to the top k logits of the evolution layer.

8. The computer-implemented method of claim 1, wherein for each of a plurality of layers that occur before the evolution layer, processing the logits of the layer with the logits of the evolution layer to generate an approximated gradient comprises for each layer from an initial layer to the evolution layer, processing the logits of the layer with the logits of the evolution layer to generate the approximated gradient.

9. The computer-implemented method of claim 8, wherein obtaining, from the LLM, logits [symbol] of an evolution layer of the LLM, comprises obtaining, from the LLM, logits [symbol] of a layer of the LLM that is prior to the final layer of the LLM.

10. A system comprising one or more computers and one or more storage devices storing instructions that are operable, when executed by the one or more computers, to cause the one or more computers to perform operations comprising:
processing, by a Large Language Model (LLM) of N layers, an input by an inference operation of the LLM;
obtaining, from the LLM, logits [symbol] of an evolution layer of the LLM, the evolution layer being subsequent to a first layer of the LLM;
for a plurality of layers that occur before the evolution layer, processing the logits of the layer with the logits of the evolution layer to generate an approximated gradient;
based on the approximated gradient and the logits of the evolution layer, generating adjusted logits for the evolution layer; and
processing the adjusted logits for the evolution layer to generate an output for the LLM.

11. The system of claim 10, wherein obtaining, from the LLM, logits [symbol] of an evolution layer of the LLM, comprises obtaining, from the LLM, logits [symbol] of a final layer of the LLM, wherein the final layer of the LLM is the evolution layer.

12. The system of claim 11, wherein for the plurality of layers that occur before the evolution layer, processing the logits of the layer with the logits of the evolution layer to generate an approximated gradient comprises for each layer of the plurality of layers that occur before the evolution layer, processing the logits of the layer with the logits of the evolution layer to generate an approximated gradient.

13. The system of claim 11, wherein generating adjusted logits for the evolution layer comprises:
for each layer of a plurality of layers that occur before the evolution layer, processing a distribution of the layer and a distribution of the final layer to determine a distance from the approximated gradient; and
for each layer of the plurality of layers that occur before the evolution layer, determining, for the layer, weights that are indicative of how closely a difference between the logits of the layer and the logits of the final layer align with the approximated gradient.

14. The system of claim 13, the operations further comprising:
determining, based on the weights, a weighted average for each layer; and
adjusting the logits of the evolution layer based, in part, on the weighted averages determined for the layers.

15. The system of claim 10, wherein processing the logits of the layer with the logits of the evolution layer to generate an approximated gradient comprises processing a proper subset of the logits of the layer, the proper subset of the logits of the layer corresponding to a set of top k logits of a layer, where k is a value that is fewer than a total number of logits in the layer.

16. The system of claim 15, wherein processing a proper subset of the logits of the layer comprises processing the proper subset of the logits of the layer that correspond to the top k logits of the evolution layer.

17. The system of claim 10, wherein for each of a plurality of layers that occur before the evolution layer, processing the logits of the layer with the logits of the evolution layer to generate an approximated gradient comprises for each layer from an initial layer to the evolution layer, processing the logits of the layer with the logits of the evolution layer to generate the approximated gradient.

18. The system of claim 17, wherein obtaining, from the LLM, logits [symbol] of an evolution layer of the LLM, comprises obtaining, from the LLM, logits [symbol] of a layer of the LLM that is prior to the final layer of the LLM.

19. A computer storage medium encoded with instructions that, when executed by one or more computers, cause the one or more computers to perform operations comprising:
processing, by a Large Language Model (LLM) of N layers, an input by an inference operation of the LLM;
obtaining, from the LLM, logits [symbol] of an evolution layer of the LLM, the evolution layer being subsequent to a first layer of the LLM;
for each of a plurality of layers that occur before the evolution layer, processing the logits of the layer with the logits of the evolution layer to generate an approximated gradient;
based on the approximated gradient and the logits of the evolution layer, generating adjusted logits for the evolution layer; and
processing the adjusted logits for the evolution layer to generate an output for the LLM.

20. The computer storage medium of claim 19, wherein obtaining, from the LLM, logits [symbol] of an evolution layer of the LLM, comprises obtaining, from the LLM, logits [symbol] of a final layer of the LLM, wherein the final layer of the LLM is the evolution layer.
